(19) United States
(12) Patent Application Publication
(10) Pub. No.: US 2010/0100853 A1
(43) Pub. Date: Apr. 22, 2010

(54) MOTION CONTROLLED USER INTERFACE

(76) Inventors: Jean-Pierre Ciudad, San Francisco, CA (US); Romain Goyet, Paris (FR); Olivier Bonnet, Paris (FR)

Correspondence Address: APPLE INC./BSTZ;BLAKELY SOKOLOFF TAYLOR & ZAFMAN LLP, 1279 OAKMEAD PARKWAY, SUNNYVALE, CA, 94085-4040, US

(21) Appl. No.: 12/254,785

(22) Filed: Oct. 20, 2008

(51) Int. Cl. G06F 3/033; G06F 3/048

(52) U.S. Cl. 715/856; 715/863

(57) ABSTRACT

A graphical user interface (GUI) is disclosed. The GUI comprises a three-dimensional virtual desktop surface. The GUI displays a view of the three-dimensional virtual desktop surface from a selected viewpoint and viewing angle and modifies at least one of the viewpoint and viewing angle based on detected head movements of a user.

### FIELD OF THE INVENTION

The present invention relates to a graphical user interface (GUI) in which a plurality of items are displayed on a virtual desktop. The invention also relates to a processing device having the GUI and a method for displaying the GUI.

### BACKGROUND

Operating systems for computers generally use a GUI to allow a user to enter commands. An image is displayed on a monitor attached to the computer and the user interacts with the computer by moving a mouse, which in turn moves a pointer or cursor within the image to a particular area of the image. The user can then press a mouse button to perform an action corresponding to that area of the image.

Conventional GUIs feature a virtual desktop, which is a portion of the image consisting of a background on which various items are displayed. The items may include icons corresponding to applications, in which case the user can run an application by moving the pointer over the corresponding icon and pressing an appropriate button. The items may also include windows representing applications that are currently running, in which case the user can select an active application by moving the pointer over the corresponding window.

One problem with such conventional GUIs is that in many cases a large number of icons and open application windows must be displayed on a relatively small virtual desktop. This makes it difficult for the user to keep track of all of the icons and windows while keeping each window big enough that the content of the window is clearly visible.

A further problem with conventional GUIs is that when a large number of items with which the user can interact are displayed on the virtual desktop, precise movements of the mouse are required to select the correct item. This increases the time it takes for a user to perform a given action such as opening a document using the GUI. The need for precise movements can also make the GUI difficult to operate for some users and can lead to erroneous commands being given via the GUI.

### SUMMARY

In order to overcome the above problems, the present invention provides a graphical user interface comprising a three-dimensional virtual desktop surface, wherein the graphical user interface displays a view of the three-dimensional virtual desktop surface from a selected viewpoint and viewing angle, and wherein the graphical user interface modifies at least one of the viewpoint and viewing angle based on detected head movements of a user in use.

By displaying a three-dimensional virtual desktop surface from various points of view, the present invention expands the effective useable area of the virtual desktop. This provides more space to accommodate icons and open windows using the same size of screen, which makes it easier for a user to see each item clearly.

Allowing the user to modify the view of the virtual desktop surface using head movements provides an intuitive user interface. The virtual desktop surface behaves similarly to a real three-dimensional object in front of the user in that different views of the surface can be obtained by head movement.

According to a second aspect of the invention, there is provided a graphical user interface comprising a virtual desktop surface, wherein the graphical user interface displays a view of the virtual desktop surface and at least one virtual item arranged on the virtual desktop surface, wherein the virtual items on a magnified part of the virtual desktop surface are displayed in magnified form compared to virtual items on other parts of the virtual desktop surface; and wherein the graphical user interface modifies which part of the virtual desktop surface is the magnified part based on detected head movements of a user in use.

Providing a magnified area on the virtual desktop surface allows items on the part of the desktop that the user is focusing on to be clearly visible. Since the other parts of the virtual desktop surface are not magnified, a large number of items can still be displayed on the screen as a whole. Selecting which part of the virtual desktop surface is magnified based on head movements provides an intuitive interface.

According to a third aspect of the invention, there is provided an information processing apparatus comprising: a processing unit; a display device; and an image capture device for capturing an image of a user and supplying the image to the processing unit; wherein the processing unit drives the display device to display a graphical user interface comprising a view of a three-dimensional virtual desktop surface, the view being from a selected virtual viewpoint and viewing angle; and wherein the processing unit calculates a position of the user's head relative to the image capture device based on the image and selects at least one of the viewpoint and viewing angle based on the calculated position of the user's head.

According to a fourth aspect of the invention, there is provided an information processing apparatus comprising: a display device having a screen for displaying an image; a head position detection unit for calculating a position of a user's head relative to the screen; and a graphical user interface generation unit for generating a graphical user interface for display on the screen, the graphical user interface comprising a projection of a three-dimensional virtual desktop surface in a virtual space onto the screen; wherein the graphical user interface generation unit controls at least one of a virtual position and a virtual orientation of the screen relative to the virtual desktop surface in the virtual space in dependence on the position of the user's head calculated by the head position detection unit.

According to a fifth aspect of the invention, there is provided an information processing apparatus comprising: a display device; a head position detection unit for detecting a position of a user's head; a pointing device for outputting a signal indicating physical motion of the pointing device; and a graphical user interface generation unit for generating a graphical user interface, the graphical user interface comprising a virtual desktop surface and a pointer overlaid on the virtual desktop surface; wherein the graphical user interface generation unit controls a view of the virtual desktop surface displayed on the display device in dependence on the position of the user's head calculated by the head position detection unit; and wherein the graphical user interface generation unit controls a position of the pointer on the virtual desktop surface in dependence on the signal output by the pointing device.

The additional control provided by the head movement interface reduces the minimum precision of pointer movements required to select items in the GUI because pointer movements only need to select between the subset of items on the part of the virtual desktop surface displayed in response to the user's head movements. The combination of two input devices, i.e. the head position detection unit and the pointing device, makes it easier for a user to select items accurately.

According to a sixth aspect of the invention, there is provided a method of displaying a plurality of icons on a screen comprising: arranging the icons on a three-dimensional virtual desktop surface defined in a virtual space; displaying on the screen a projection of the virtual desktop surface onto a virtual screen defined in the virtual space; detecting a position of a user's head relative to the screen; and modifying a position of the virtual screen relative to the virtual desktop surface in the virtual space based on the detected position of the user's head.

### BRIEF DESCRIPTION OF THE DRAWINGS

Embodiments of the present invention will now be described by way of further example only and with reference to the accompanying drawings, in which:

FIG. 1 is a schematic diagram illustrating an information processing apparatus according to an embodiment of the invention;

FIG. 2 shows a virtual desktop surface and a virtual screen arranged in a virtual space according to an embodiment of the invention;

FIG. 3 illustrates a view of a virtual desktop surface on a screen according to an embodiment of the invention;

FIG. 4 illustrates an information processing apparatus according to an embodiment of the invention and a user of the device; and

FIG. 5 is a functional schematic diagram illustrating an information processing apparatus according to an embodiment of the invention.

FIG. 6 illustrates an exemplary embodiment of a computer system 1800 in which a GUI of the present invention may be realized.

### DETAILED DESCRIPTION

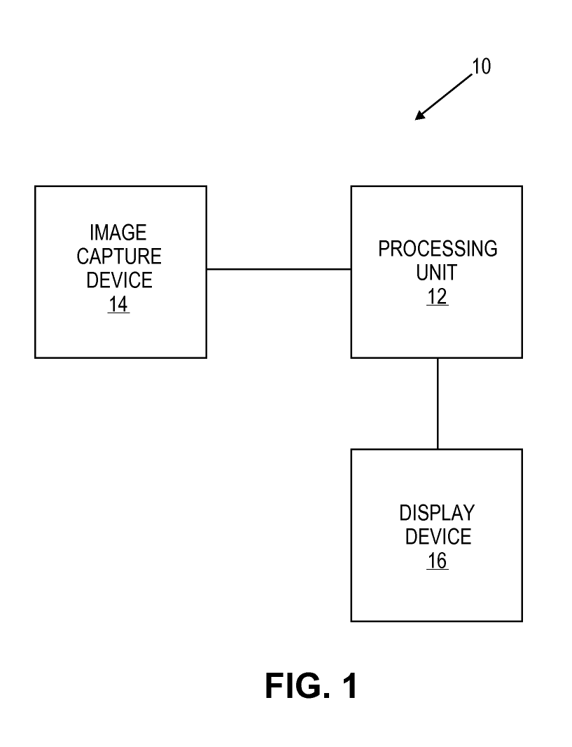

An embodiment of the invention is an information processing apparatus 10 as shown in FIG. 1, comprising a processing unit 12 coupled to a display device 16 and an image capture device 14. The image capture device 14 and the display device 16 are in communication with the processing unit 12 via a wired or wireless connection. The processing unit 12 and the display device 16 may be parts of a desktop computer in this embodiment. In an alternative embodiment, the processing unit 12, the display device 16 and the image capture device 14 may all be incorporated in a laptop computer.

The image capture device 14 may be a digital camera, which is directed so as to be able to capture images of the face of a user operating the desktop computer. The processing unit 12 instructs the camera 14 to capture an image, in response to which the camera 14 performs the image capture and transmits the image to the processing unit 12.

The display device 16 may be a CRT or LCD monitor, or any other display suitable for presenting a GUI. The processing unit 12 runs an operating system having a GUI, which is displayed by the display device 16.

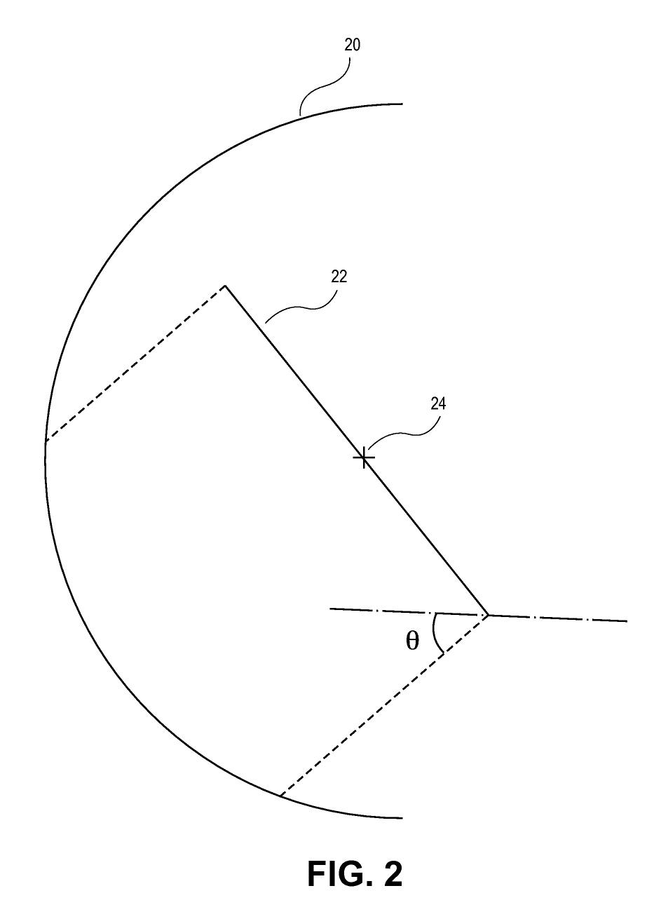

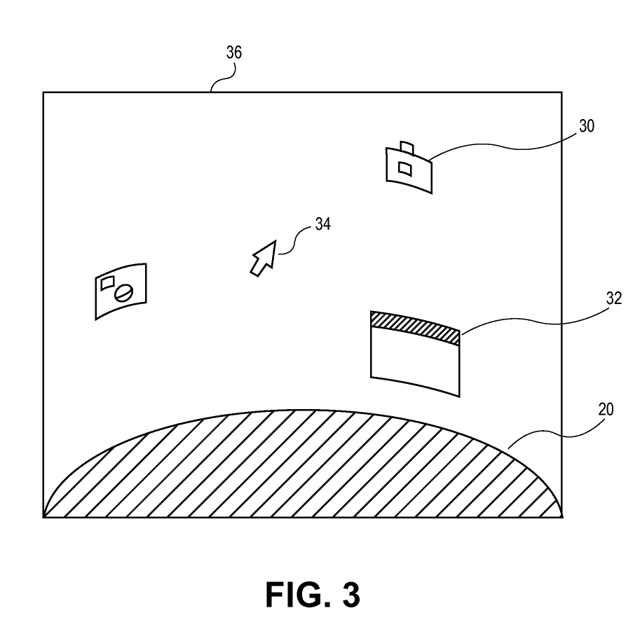

As shown in FIGS. 2 and 3, the GUI comprises a three-dimensional virtual desktop surface 20, on which various items are displayed. FIG. 2 is a schematic diagram showing a plan view of the virtual desktop surface 20 and a virtual screen 22, which represents the screen 36 of the display device 16 in the virtual space occupied by the virtual desktop surface 20. The processing unit 12 provides the GUI by drawing a view of the virtual desktop surface 20 from a selected viewpoint and then instructing the display device 16 to display the view. The view actually shown on the screen 36 is the projection of the virtual desktop surface 20 onto the virtual screen indicated by the dashed lines in FIG. 2.

FIG. 3 illustrates the view displayed on the screen 36. The view shown in FIG. 3 is a perspective view of a curved three-dimensional virtual desktop surface 20. The items displayed on the desktop include icons 30 representing applications and files as well as windows 32 in which currently open applications are displayed. A pointer 34 is also displayed on the screen 36. In this embodiment, the virtual desktop surface 20 has a curved shape in the form of the inside of a half-cylinder, as illustrated in FIG. 2. The virtual desktop surface 20 has a larger surface area than that of the virtual screen 22.

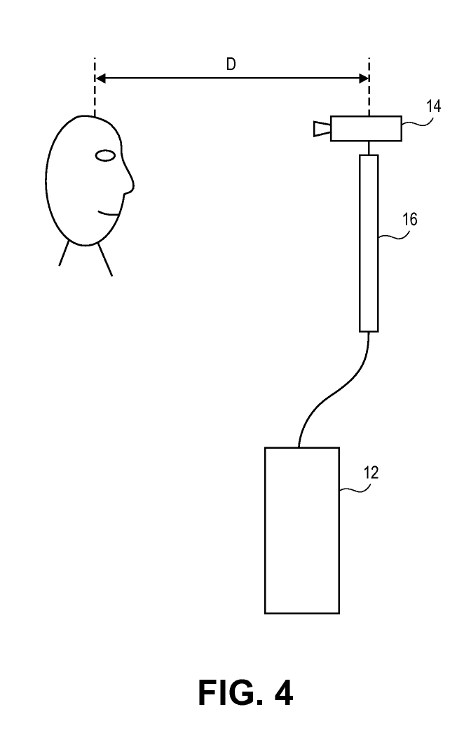

The user sits in front of the display device 16 as shown in FIG. 4, facing the display device 16. The camera 14 captures an image of the face of the user and sends the image to the processing unit 12. The camera 14 is in a fixed location relative to the display device 16, so there is a correlation between the position of the user's face relative to the camera 14 and the position of the user's face relative to the display device 16. For example, the camera 14 may be mounted to the top of the display device 16. The position of the user's face relative to the camera 14 can be inferred from the position of the user's face in the received image. The processing unit 12 calculates the position of the user's face relative to the display device 16 from the received image and adjusts the viewpoint based on the calculated position.

The processing unit 12 extracts the positions of the user's eyes from the image using a face recognition algorithm. Such face recognition algorithms are known in the art. The processing unit 12 calculates the horizontal and vertical positions of the user's face and hence the user's head relative to the camera 14 based on the horizontal and vertical positions of the user's eyes in the image. The processing unit 12 also calculates the distance D of the user's head from the camera 14 based on the separation between the positions of the user's eyes in the image. The user's eyes will appear further apart as the user's head moves closer to the camera 14.

The positions and separation of the user's eyes depend not only on head movement but also on the initial seating position and eye separation of the user. To take account of this, the information processing apparatus 10 captures an initial image and calculates the positions and separation of the user's eyes in subsequent images relative to their values in the initial image.

Having calculated the position of the user's face in three-dimensional space relative to the camera 14 and relative to its initial position, the processing unit 12 calculates a viewpoint and/or viewing angle for the virtual desktop surface 20 based on the calculated position. In this embodiment, the processing unit 12 changes the horizontal viewing angle θ in response to horizontal head movements so that a different section of the half-cylindrical surface becomes visible.

The distance of the user's head from the camera 14 is used to control how close the viewpoint is to the virtual desktop surface 20, to provide a zoom function. Specifically, the processing unit 12 moves the viewpoint closer to or further from the virtual desktop surface 20 in response to detecting that the user's head has moved closer to or further from the camera 14 respectively. This allows the user to examine the part of the virtual desktop surface 20 displayed at the centre of the screen 36 more closely or to zoom out to view the entire virtual desktop surface 20.

Forward head movements, i.e. head movements toward the camera 14, may also be used to select the item on the virtual desktop surface 20 displayed at the centre of the screen or the item over which the pointer is placed. For example, in response to detecting a forward head movement, the processing unit 12 could open the application corresponding to an icon displayed at the centre of the screen.

The virtual desktop surface 20 may be larger than the screen of the display device 16 in a vertical direction, i.e. the direction along the cylindrical axis of the half-cylinder. In this case, the vertical position of the viewpoint is controlled by vertical head movements.

The information processing apparatus 10 also features a pointing device such as a mouse, which controls a pointer 34 displayed on the display device 16. The pointer 34 is overlaid on the view of the virtual desktop surface 20 shown on the display device 16 and the position of the pointer 34 is changed in correspondence with the position of the pointing device. The position of the pointing device is detected by the processing unit 12. The pointer 34 moves in the coordinate system of the screen of the display device 16 rather than the coordinate system of the virtual desktop surface 20 in this embodiment.

By controlling the section of the virtual desktop surface 20 displayed using horizontal head movements and controlling the apparent distance of the virtual desktop surface 20 from the screen using head movements toward and away from the camera 14, the user can select the portion of the virtual desktop surface 20 displayed on the screen. Using the pointing device, the user can then select a particular item located within this portion of the virtual desktop surface 20. The graphical user interface uses a combination of head movements, controlling the projection of the virtual desktop surface 20, and hand movements, controlling the pointer position in the coordinate system of the screen via the pointing device. This combination allows the user to select an item on the virtual desktop surface 20 using less precise movements of any one part of the body and avoids putting constant strain on any one part of the body.

Head movements detected by the processing unit 12 can be correlated to movements of the viewpoint and viewing angle of the GUI in various ways. For example, each possible viewpoint position may be mapped to a particular head position, so that the user simply has to move his/her head to a given position in order to obtain a desired viewpoint.

Alternatively, a range of head positions may be mapped to a velocity of the viewpoint. In this configuration, the user's head is detected to be within one of a plurality of preset regions relative to the camera 14. The velocity of the viewpoint is set depending on which region the user's head is in. The viewpoint continues to move at the set velocity until the user's head moves to a region corresponding to a different velocity.

In the same way as for the viewpoint, each viewing angle may be mapped to a particular head position or an angular velocity of the viewing angle may be set in accordance with which region the user's head is in.

Many different shapes are possible for the virtual desktop surface 20. For example, the virtual desktop surface 20 may be the inside or the outside of hollow shapes including a half-sphere, a sphere, a half-ellipsoid, an ellipsoid, a cuboid and an open box.

In an alternative embodiment, the virtual desktop surface 20 is two-dimensional and a selected part of the virtual desktop surface 20 is displayed in magnified form relative to the other parts. In this embodiment, the user's head movements are detected by the processing unit 12 in the same way as described above, but instead of being used to change the viewpoint and viewing angle of the GUI they are used to change the part of the virtual desktop surface 20 that is magnified. For example, if the processing unit 12 detects that the user's head is located up and to the right compared to its original position relative to the camera 14, an upper-right part of the virtual desktop surface 20 is displayed in magnified form.

Using this embodiment of the invention, a user can magnify a desired part of the virtual desktop simply by moving his/her head. Icons and open windows located in that part of the virtual desktop then become easily visible. The other parts of the virtual desktop remain visible, although on a smaller scale. Hence, the user can focus on one area of the virtual desktop while keeping track of items in the other areas.

Of course, the embodiments described above may be combined so that the virtual desktop surface 20 is three-dimensional and part of the virtual desktop surface 20 is magnified. In this combination, head movements may be correlated to the viewpoint and viewing angle, the part of the virtual desktop surface 20 that is magnified, or both.

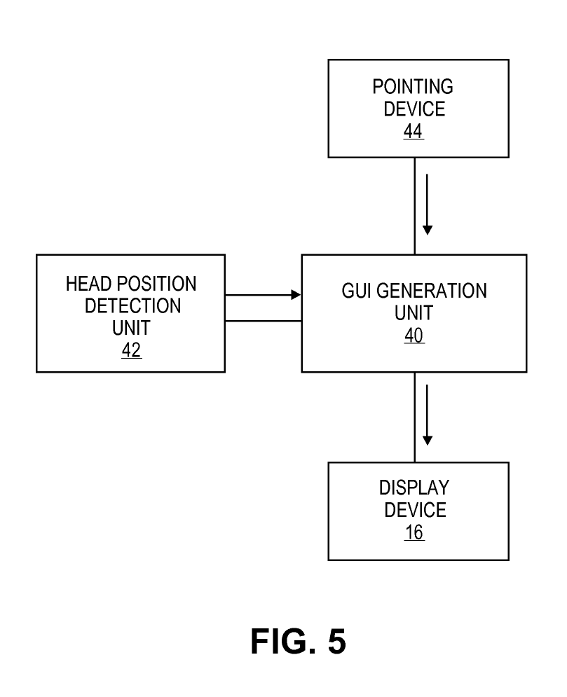

FIG. 5 illustrates an embodiment of the present invention in a functional block form. FIG. 5 shows a head position detection unit 42, a pointing device 44 and a GUI generation unit 40. The head position detection unit 42 detects and outputs the position of a user's head relative to the display device 16. The head position detection unit 42 corresponds to the image capture device 14 and the face recognition algorithm in the embodiments described above, but is not limited to these components. The pointing device 44 produces a signal indicating motion of the pointing device 44. In a preferred embodiment, the pointing device 44 is a mouse.

The GUI generation unit 40 draws a GUI based on the position of the user's head detected by the head position detection unit 42 and the output signal from the pointing device 44. The function of the GUI generation unit 40 is performed by the processing unit 12 in the embodiments described above. The GUI generation unit 40 can provide any of the GUI features in the embodiments described above.

Although the embodiments described above use an image capture device 14 and a face recognition algorithm to detect the position of a user's head, any means of detecting the position of the user's head can be used in the present invention. For example, an accelerometer could be attached to the user's head to detect head movements and communicate the movements to the processing unit 12.

Furthermore, it is not necessary for a face recognition algorithm to extract positions of a user's eves in order to detect the position of a user's head using an image capture device. Various forms of image processing can be used to extract the position of the user's head relative to the image capture device from a captured image.

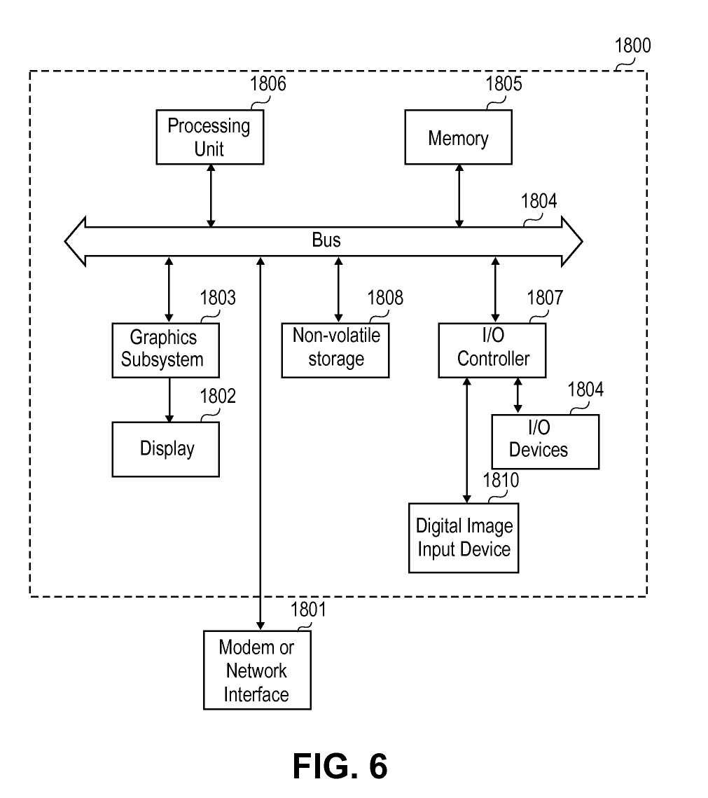

FIG. 6 illustrates an exemplary embodiment of a computer system 1800 in which a GUI of the present invention may be realized. Computer system 1800 may form part of a desktop computer, a laptop computer, a mobile phone or any other information processing device. It may be used as a client system, a server computer system, or as a web server system, or may perform many of the functions of an Internet service provider.

The computer system 1800 may interface to external systems through a modem or network interface 1801 such as an analog modem, ISDN modem, cable modem, token ring interface, or satellite transmission interface. As shown in FIG. 6 the computer system 1800 includes a processing unit 1806, which may be a conventional microprocessor, such as an Intel Pentium microprocessor, an Intel Core Duo microprocessor, or a Motorola Power PC microprocessor, which are known to one of ordinary skill in the computer art. System memory 1805 is coupled to a processing unit 1806 by a system bus 1804. System memory 1805 may be a DRAM, RAM, static RAM (SRAM) or any combination thereof. Bus 1804 couples processing unit 1806 to system memory 1805, to non-volatile storage 1808, to graphics subsystem 1803 and to input/output (I/O) controller 1807. Graphics subsystem 1803 controls a display device 1802, for example a cathode ray tube (CRT) or liquid crystal display, which may be part of the graphics subsystem 1803. The I/O devices may include a keyboard, disk drives, printers, a mouse, and the like as known to one of ordinary skill in the computer art. The pointing device present in some embodiments of the invention is one such I/O device. A digital image input device 1810 may be a scanner or a digital camera, which is coupled to I/O controller 1807. The image capture device present in some embodiments of the invention is one such digital image input device 1810. The non-volatile storage 1808 may be a magnetic hard disk, an optical disk or another form for storage for large amounts of data. Some of this data is often written by a direct memory access process into the system memory 1806 during execution of the software in the computer system 1800.

The aforegoing description has been given by way of example only and it will be appreciated by a person skilled in the art that modifications can be made without departing from the scope of the present invention.

1. A graphical user interface comprising a three-dimensional virtual desktop surface, wherein the graphical user interface displays a view of the three-dimensional virtual desktop surface from a selected viewpoint and viewing angle, and
wherein the graphical user interface modifies at least one of the viewpoint and viewing angle based on detected head movements of a user in use.

2. The graphical user interface according to claim 1, further comprising a pointer, wherein the position of the pointer is controlled by a pointing device.

3. The graphical user interface according to claim 2, wherein the view is a projection of the virtual desktop surface onto a screen, the pointer is displayed on the screen and movements of the pointing device are mapped to movements of the pointer across the screen.

4. The graphical user interface according to claim 1, wherein the virtual desktop surface has a concave shape.

5. The graphical user interface according to claim 1, wherein the virtual desktop surface has a convex shape.

6. The graphical user interface according to claim 1, wherein the virtual desktop surface is in the shape of a half-cylinder.

7. The graphical user interface according to claim 1, wherein detectable positions of the user's head are mapped to virtual positions of the viewpoint.

8. The graphical user interface according to claim 1, wherein detectable positions of the user's head are mapped to virtual velocities of the viewpoint.

9. The graphical user interface according to claim 1, wherein detectable positions of the user's head are mapped to viewing angles.

10. The graphical user interface according to claim 1, wherein detectable positions of the user's head are mapped to virtual angular velocities of the viewing angle.

11. The graphical user interface according to claim 1, wherein the graphical user interface modifies the viewpoint and viewing angle in response to detected head movements in the same way that the viewpoint and viewing angle would change if the virtual desktop surface were a physical object.

12. A graphical user interface comprising a virtual desktop surface, wherein the graphical user interface displays a view of the virtual desktop surface and at least one virtual item arranged on the virtual desktop surface,
wherein the virtual items on a magnified part of the virtual desktop surface are displayed in magnified form compared to virtual items on other parts of the virtual desktop surface; and
wherein the graphical user interface modifies which part of the virtual desktop surface is the magnified part based on detected head movements of a user in use.

13. An information processing apparatus comprising:
a processing unit;
a display device; and
an image capture device for capturing an image of a user and supplying the image to the processing unit;
wherein the processing unit drives the display device to display a graphical user interface comprising a view of a three-dimensional virtual desktop surface, the view being from a selected virtual viewpoint and viewing angle; and
wherein the processing unit calculates a position of the user's head relative to the image capture device based on the image and selects at least one of the viewpoint and viewing angle based on the calculated position of the user's head.

14. The information processing apparatus according to claim 13, wherein the processing unit includes a face recognition unit for identifying the positions of the user's eyes in the image, and
wherein the processing unit calculates the position of the user's head based on the positions of the user's eyes in the image.

15. The information processing apparatus according to claim 14, wherein the processing unit calculates the distance of the user's head from the image capture device based on a separation distance between the user's eyes in the image.

16. The information processing apparatus according to claim 13, further comprising a pointing device controlling a virtual pointer overlaid on the view of the virtual desktop surface in the graphical user interface.

17. The information processing apparatus according to claim 13, wherein the processing unit selects the viewpoint and viewing angle based on the displacement of the user's head from an initial position calculated by the processing unit.

18. An information processing apparatus comprising:
a display device having a screen for displaying an image;
a head position detection unit for calculating a position of a user's head relative to the screen; and
a graphical user interface generation unit for generating a graphical user interface for display on the screen, the graphical user interface comprising a projection of a three-dimensional virtual desktop surface in a virtual space onto the screen;
wherein the graphical user interface generation unit controls at least one of a virtual position and a virtual orientation of the screen relative to the virtual desktop surface in the virtual space in dependence on the position of the user's head calculated by the head position detection unit.

19. The information processing apparatus according to claim 18, wherein the head position detection unit comprises:
an image capture device for capturing an image of the user; and
a face recognition unit for identifying a position of the user's face in the image.

20. An information processing apparatus comprising:
a display device:
a head position detection unit for detecting a position of a user's head;
a pointing device for outputting a signal indicating physical motion of the pointing device; and
a graphical user interface generation unit for generating a graphical user interface, the graphical user interface comprising a virtual desktop surface and a pointer overlaid on the virtual desktop surface;
wherein the graphical user interface generation unit controls a view of the virtual desktop surface displayed on the display device in dependence on the position of the user's head calculated by the head position detection unit; and
wherein the graphical user interface generation unit controls a position of the pointer on the virtual desktop surface in dependence on the signal output by the pointing device.

21. The information processing apparatus according to claim 20, wherein the head position detection unit comprises:
an image capture device for capturing an image of the user; and
a face recognition unit for identifying a position of the user's face in the image.

22. The information processing apparatus according to claim 20, wherein the virtual desktop surface is a three-dimensional surface and the view is defined by a viewpoint and a viewing angle.

23. The information processing apparatus according to claim 20, wherein the virtual desktop surface has a magnified part, items arranged on the magnified part being displayed in a magnified form compared to items arranged on other parts of the virtual desktop surface, and
wherein the view is defined by the location of the magnified part on the virtual desktop surface.

24. A method of displaying a plurality of icons on a screen comprising:
arranging the icons on a three-dimensional virtual desktop surface defined in a virtual space;
displaying on the screen a projection of the virtual desktop surface onto a virtual screen defined in the virtual space;
detecting a position of a user s head relative to the screen; and
modifying a position of the virtual screen relative to the virtual desktop surface in the virtual space based on the detected position of the user's head.
